(19) United States
(12) Patent Application Publication
(10) Pub. No.: US 2026/0201637 A1
(43) Pub. Date: Jul. 16, 2026

(54) FABRIC, GARMENT, AND METHOD FOR MANUFACTURING FABRIC

(71) Applicant: HOT FACTORY Co.,Ltd., Osaka (JP)

(72) Inventors: Shigeo ANNAKA, Osaka (JP); Ryosuke TARUI, Osaka (JP); Tetsuya OKAZAKI, Osaka (JP)

(21) Appl. No.: 19/561,512

(22) Filed: Mar. 10, 2026

Related U.S. Application Data
(63) Continuation of application No. PCT/JP2024/037739, filed on Oct. 23, 2024.

(30) Foreign Application Priority Data
Oct. 23, 2023 (JP) 2023-181871

(51) Int. Cl. D06P 1/673

(52) U.S. Cl. CPC D06P 1/67383; D10B 2401/04; D10B 2501/00

(57) ABSTRACT

A fabric having both a function of dissipating heat from the fabric and fabric stretchability is to be provided. The fabric includes a base fabric, and a printed layer printed on the front side of the base fabric. In the fabric, the printed layer contains functional material powder having a function of dissipating heat from the fabric. On the front side of the base fabric, a pattern in which a large number of printed portions constituting the printed layer are two-dimensionally and repeatedly arranged is formed, and in the region in which the pattern is formed, the proportion of the area of the printed layer in the region in which the pattern is formed is 35% or larger and 65% or smaller, and the area of each of the printed portions is 7 mm² or smaller.

### CROSS-REFERENCE TO RELATED APPLICATIONS

This application claims the benefit of priority and is a Continuation application of the prior International Patent Application No. PCT/JP2024/037739, with an international filing date of Oct. 23, 2024, which designated the United States, and is related to the Japanese Patent Application No. 2023-181871, filed Oct. 23, 2023, the entire disclosures of all applications are expressly incorporated by reference in their entirety herein.

### TECHNICAL FIELD

The present invention relates to a fabric or the like to be used for a garment or the like.

### BACKGROUND ART

Fabrics having various functions have been developed. Patent Literature 1 discloses a cool feeling fabric that can maintain a cool feeling effect for a longer time. In this cool feeling fabric, in addition to microcapsules containing a phase transition substance having a melting point of 20 to 39° C., a material containing a cool-touch material formed with at least one material selected from the group consisting of water-absorbent resins, gel-like substances, and silicone resins is used as a cool feeling material layer, and therefore, when the body comes into contact with the cool feeling material layer, both heat absorption by dissolution of the phase transition substance contained in the microcapsules and heat absorption by the cool-touch material act. The cool feeling fabric disclosed in Patent Literature 1 is used for spun fabrics (bed pads, quilt covers, comforters, and the like) in which other fabrics or the like are stacked.

### PRIOR ART TECHNICAL DOCUMENT

### Patent Document

Patent Literature 1: JP 2021-66995

### DESCRIPTION OF THE DISCLOSURE

### [Problem(s) to be Solved by the Disclosure]

Meanwhile, the inventors of the present application considered providing a printed layer containing functional material powder having a function of dissipating heat (this function will be hereinafter referred to as the heat dissipating function in some cases) on a base fabric, to obtain a garment in which heat hardly accumulates in the fabric while being worn by a person. In this case, the heat dissipating function improves in proportion to the increase in the proportion of the area of the printed layer to the base fabric. However, when the proportion of the area of the printed layer is made too large, or when the individual printed portions constituting the printed layer are made too large, there is a possibility that the stretchability (in particular, the stretch-back properties after being stretched) of the fabric will be degraded.

The present invention has been made in view of such circumstances, and aims to provide a fabric having both a function of dissipating heat from the fabric and fabric stretchability.

### Means for Solving the Problems

To achieve both a function of dissipating heat from the fabric and fabric stretchability, the inventors of the present application have conceived of forming a pattern in which a large number of printed portions constituting a printed layer are two-dimensionally and repeatedly arranged to reduce the area of each printed portion while securing the proportion of the area of the printed layer on the front side of the base fabric. A first invention based on this idea is a fabric that includes: a base fabric; and a printed layer printed on the front side of the base fabric, wherein the printed layer contains functional material powder having a function of dissipating heat from the fabric, a pattern in which a large number of printed portions constituting the printed layer are two-dimensionally and repeatedly arranged is formed on the front side of the base fabric, and in the region in which the pattern is formed, the proportion of the area of the printed layer is 35% or larger and 65% or smaller, and the area of each of the printed portions is 7 mm² or smaller.

A second invention is the first invention in which the printed layer contains only polycrystalline polysilicon as the functional material powder having the function of dissipating heat from the fabric.

A third invention is the first invention in which the fabric portion in the region in which the pattern is formed has a heat retention rate of 6.0% or higher and 8.2% or lower.

A fourth invention is the first invention in which the pattern is formed over the entire surface on the front side of the base fabric.

A fifth invention is a garment for which the fabric of any one of the first to fourth inventions is used.

A sixth invention is a method for manufacturing a fabric, the method including a printing step of performing printing on a front side of a base fabric with a printing apparatus using an ink in which at least functional material powder having a function of dissipating heat from the fabric and a binder are blended, and forming a printed layer on the front side of the base fabric, wherein the printing step is a step of forming a pattern in which a large number of printed portions constituting the printed layer are two-dimensionally and repeatedly arranged on the front side of the base fabric, and in print data to be used as input data for the printing apparatus, in a region in which the pattern is formed, a proportion of area of the printed layer is 30% or larger and 60% or smaller, and the area of each of the printed portions is 6 mm² or smaller.

### Effect of the Disclosure

In the present invention, in the region in which the pattern is formed on the front side of the base fabric, the proportion of the area of a printed layer (the proportion of the total area of printed portions to the area of the region in which the pattern is formed) is 35% or larger and 65% or smaller, and the area of each of the printed portions is 7 mm² or smaller. That is, in the region in which the pattern is formed (the region having a heat dissipating function) in a fabric according to the present invention, small printed portions each having an area of 7 mm² or smaller (printed portions each having a side of 2.65 mm or shorter in a case where the planar shape of the printed portions is a square, for example) are two-dimensionally and repeatedly arranged, while securing the proportion of the area of the printed layer of equal to or larger than 35% and equal to or smaller than 65%. Thus, a fabric having both a function of dissipating heat from the fabric and fabric stretchability can be obtained.

### BRIEF DESCRIPTION OF THE DRAWINGS

FIGS. 1A and 1B are perspective views of the front side of a fabric according to an embodiment; and

FIG. 2 is a cross-sectional view of the front side of a fabric according to an embodiment.

### MODES FOR CARRYING OUT THE DISCLOSURE

The following is a detailed description of an embodiment of the present invention, with reference to the drawings. Note that the embodiment described below is an example of the present invention, and is not intended to limit the scope of the present invention, its application, or its use.

### [Fabric]

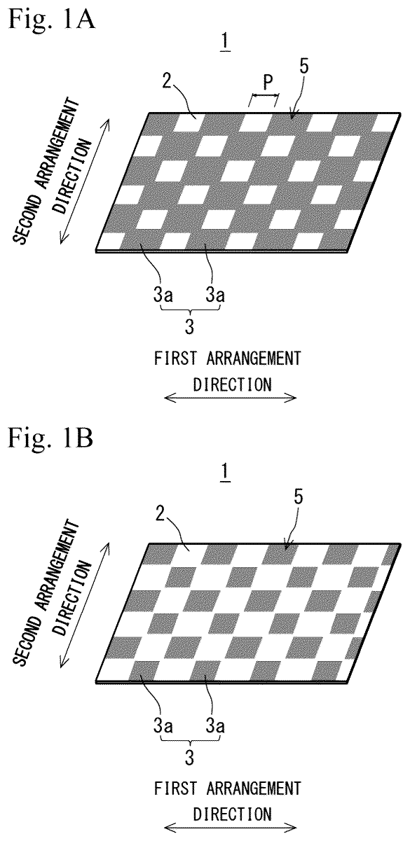

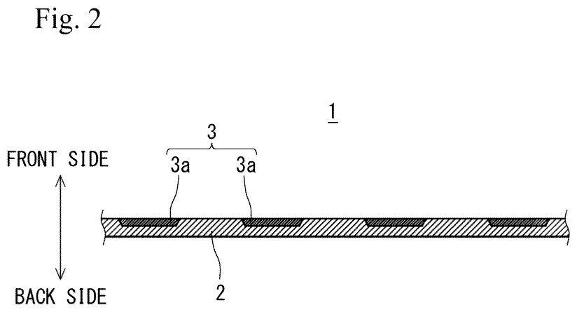

The present embodiment is a fabric 1 subjected to heat dissipation finishing for dissipating heat. As shown in FIGS. 1A and 1B, and FIG. 2, the fabric 1 includes a base fabric 2, and a printed layer 3 that is printed on the front side of the base fabric 2. The printed layer 3 contains functional material powder having a function of dissipating heat from the fabric 1 (a heat dissipating function). The printed layer 3 contains only polycrystalline polysilicon as the functional material powder having a heat dissipating function.

The base fabric 2 is a fabric that is used as a material of a garment or the like. As for the front and back of the base fabric 2, when the base fabric 2 is used for a garment, the front side of the base fabric 2 serves as the outer side of the garment. In the case of a garment to be directly worn (a garment formed with a single fabric 1) such as a shirt, the body of the wearer comes into contact with the back side of the base fabric 2.

As the base fabric 2, a woven fabric or a non-woven fabric having a high cool-touch value (QMAX) can be used. The cool-touch value (QMAX) is 0.2 W/cm² or higher, for example. The cool-touch value (QMAX) is measured on the basis of JIS L1927.

As the base fabric 2, a woven fabric manufactured using a yarn formed with plant fibers (cotton, hemp, or the like), animal fibers (silk or the like), synthetic fibers (nylon, polyester, acrylic, or the like), regenerated fibers (Tencel fibers or the like), or semi-synthetic fibers, a yarn obtained by blending two or more kinds of fibers selected from these fibers and the like can be used, or a non-woven fabric using one or more kinds of the above-mentioned fibers and the like can be used. Specific examples of the base fabric 2 include a fabric using polymer polyethylene fibers and a fabric using nylon fibers.

The printed layer 3 includes a large number of printed portions 3a (Over 50 printed portions). On the front side of the fabric 1, a pattern 5 in which the large number of printed portions 3a constituting the printed layer 3 are two-dimensionally and repeatedly arranged is formed. That is, the predetermined pattern 5 is drawn with the large number of printed portions 3a. In the pattern 5, a printed portion 3a represents one figure. The planar shape of the figure (a printed portion 3a) is not limited to any particular shape, and may be a rectangle, a circle, or a shape imitating an animal, for example.

As illustrated in FIG. 1A, the pattern 5 can be formed with a large number of printed portions 3a that are regularly arranged. In this case, the large number of printed portions 3a are two-dimensionally arrayed in a repetitive manner at a constant pitch P. In the pattern 5, the large number of printed portions 3a may be irregularly arranged.

As for the arrangement of the printed portions 3a, the staggered arrangement shown in FIGS. 1A and 1B may be adopted, or some other arrangement (a block-tone arrangement, a parallel arrangement, or the like) may be adopted. For example, in the case of the staggered arrangement, the arrangement directions of the printed portions 3a may be the two directions of the longitudinal direction and the lateral direction, or may be some other directions (a combination of oblique directions). The printed portions 3a adjacent to each other in the arrangement directions (longitudinal direction or lateral direction) are arranged at a distance from each other, but may partially overlap the printed portions 3a in the adjacent rows and columns as illustrated in FIG. 1A, or may be arranged so as not to overlap the printed portions 3a in the adjacent rows and columns as illustrated in FIG. 1B.

In the region in which the pattern 5 is formed (printed layer 3), the repetition pitch (repeat) of each pattern piece (printed portion 3a) of the pattern 5 is relatively short, and is 3 mm or shorter (preferably 2.5 mm or shorter), for example, in both the longitudinal direction and the lateral direction. Also, in the region in which the pattern 5 is formed, the area of each of the printed portions 3a is 7 mm² or smaller (preferably 5 mm² or smaller). As for the color of the printed layer 3 (each printed portion 3a), gray is adopted so that the fabric 1 generates a feeling of coolness. Note that the color of the printed layer 3 is not limited to gray.

The pattern 5 is formed over the entire front surface of the base fabric 2. That is, the pattern 5 is drawn over the entire surface of the front side of the fabric 1 (the entire area of the base fabric 2). Although the pattern 5 occupies most (for example, 70% or more) of the entire area of the front side of the fabric 1 of a garment, a region in which the printed layer 3 (pattern 5) is partially absent may be provided.

In the region where the pattern 5 is formed, the proportion of the area (the ratio of the area) of the printed layer 3 with respect to the area of the region is equal to or larger than 35% and equal to or smaller than 65%. As the proportion of the area of the printed layer 3 is secured, the fabric portion in the region in which the pattern 5 is formed has a high heat dissipating function, and its heat retention rate is equal to or higher than 6.0% and equal to or lower than 8.2% (preferably, equal to or higher than 6.0% and equal to or lower than 8.0%).

In the present embodiment, the printed layer 3 contains only polysilicon as the functional material powder (ceramic powder) having the function (heat dissipating function) of dissipating heat from the fabric 1. Here, polysilicon is one of semiconductors using silicon as a raw material, and has a good thermal conductivity and a high thermal diffusivity. Note that a functional material having a heat dissipating function refers to a substance having a thermal conductivity of 50 W/m·K or higher.

### [Method for Manufacturing Fabric]

Next, a method for manufacturing the fabric 1 is described. By the method for manufacturing the fabric 1, an ink producing step of producing ink, and a printing step of performing printing on one surface (front-side surface) of the base fabric 2 with the ink obtained in the ink producing step are carried out in this order.

In the ink producing step, the functional material powder (powder of an active ingredient) for dissipating heat from the fabric 1, and a material other than the functional material are prepared as the materials of the ink. As the functional material powder, a polysilicon powder is prepared. As the material other than the functional material, a binder (print paste) is prepared. The polysilicon powder is then kneaded into the binder at a blending ratio such that the polysilicon powder accounts for 3 wt % to 5 wt % in the entire materials of the ink, and thus, the ink is produced.

Because it is possible to use a binder in which a resin film is thinned by pulverization of polycrystalline polysilicon, a soft binder is used as the binder. The soft binder is a resin having a soft texture. As the soft binder is used, the fabric 1 that is pleasant to the touch is obtained. As the soft binder, an acrylic acid ester can be used.

In the printing step, the base fabric 2 is set on a printing apparatus, and the printing apparatus performs printing on the front side of the base fabric 2 using the ink obtained in the ink producing step. Thus, the pattern 5 including the printed layer 3 is formed on the base fabric 2. As the printing apparatus, a machine printer, a rotary printing machine, a screen printing stand, an automatic screen printing machine, or the like can be used. Through the above steps, the fabric 1 according to the embodiment is completed.

Note that each printed portion 3a printed on the base fabric 2 is larger in size than each printed portion 3a of the pattern 5 on the print data used as the input data for the printing apparatus. This is because the ink is slightly diffused in the base fabric 2 during the textile printing by the printing apparatus. For example, in the print data, in the region in which the pattern 5 is formed, the proportion of the area of the printed layer is equal to or larger than 30% and equal to or smaller than 60%, and the area of each printed portion 3a is equal to 6 mm² or smaller (preferably, 4.5 mm² or smaller). Note that the degree of diffusion of the ink in the base fabric 2 varies depending on the type of the base fabric 2, for example.

The fabric 1 can be used as the fabric for any garment. For example, the fabric 1 can be used as the fabric of a shirt (a T-shirt, a long-sleeved T-shirt, or the like) formed with a single fabric, the lining of a suit jacket, suit trousers, a light blouson, or the like. The fabric 1 can also be used as the fabric of a tent.

### Effects of Embodiment

In the present embodiment, in the region in which the pattern 5 is formed on the front side of the base fabric 2, the proportion of the area of the printed layer 3 is equal to or larger than 35% and equal to or smaller than 65%, and the area of each of the printed portions 3a is 7 mm² or smaller. That is, in the fabric 1 according to the present embodiment, the printed portions 3a each having an area of 7 mm² or smaller are two-dimensionally and repeatedly arranged while securing the proportion of the area of the printed layer 3 of equal to or larger than 35% and equal to or smaller than 65% in the region in which the pattern 5 is formed (the region having a heat dissipating function). Thus, the fabric 1 having both a function of dissipating heat from the fabric 1 and fabric stretchability can be obtained.

In the present embodiment, the above-mentioned functional material powder used for the printed layer 3 is only polycrystalline polysilicon. In the ink that is used for printing the base fabric 2, only polycrystalline polysilicon is blended as the functional material powder.

Here, the inventors of the present application paid attention to the properties of polysilicon (polycrystalline silicon), which is one of semiconductors, and conducted intensive studies on a finishing method for the fabric 1 capable of effectively dissipating heat from the fabric 1. As a result, the inventors found that, by performing printing on the front side of the base fabric 2 using an ink containing only polysilicon as an active ingredient, a heat dissipating effect of dissipating heat from the fabric 1 can be obtained in a preferred manner. Polysilicon is one of semiconductors containing silicon as a raw material, has a high thermal conductivity and a high thermal diffusivity, is an easily available raw material, and is safe for the human body. The printed layer 3 containing only polysilicon as an active ingredient converts heat on the heat source side with energy of electromagnetic waves, and moves, absorbs, and diffuses the heat in the opposite direction from the fabric 1. The fabric 1 is not cooled but has a function of continuously dissipating thermal energy to the outside of the fabric 1 (that is, a function of continuously dissipating the thermal energy accumulated inside the fabric 1 to the outside, without allowing it to remain therein). According to the present embodiment, it is possible to provide a method for manufacturing the fabric 1 capable of effectively dissipating heat from the fabric 1 (dissipating heat accumulated inside the fibers of the fabric 1 to the outside) with a simple composition.

The fabric 1 according to the present embodiment removes the heat accumulated therein, so that, in a garment using the fabric 1, the heat accumulated between the human body and the garment is converted into electromagnetic waves and escapes to the outside of the garment. Thus, discomfort in the garment can be reduced. According to the present embodiment, it is possible to provide a method for manufacturing the fabric 1 capable of effectively dissipating heat with a simple composition, as one of measures against the heat, for example.

Note that polysilicon characteristically prevents various light rays. Therefore, the fabric 1 can also have an effect of preventing ultraviolet rays and an effect of preventing far infrared rays. With the latter effect, in a garment using the fabric 1, sensory temperature drops. Here, a cool feeling fabric having a high thermal conductivity has a drawback in that the function deteriorates with time. To counter this, in the present embodiment, it is possible to prevent the functional deterioration, which is the drawback, and maintain the cool feeling function.

### EXAMPLES

Examples of the present invention are now described. Note that the present invention is not limited to the examples, as long as the gist of the invention is not exceeded.

### [Test 1: Comparative Test Using Test Method Simulating 45-Degree Parallel Re-Radiation Method]

To verify the effect of printing finish in which printing is performed using an ink in which only polysilicon was blended as the functional material powder, a comparative test using a test method simulating a 45-degree parallel re-radiation method was performed. In this test, for each of the three types of base fabrics shown in Table 1, test samples with printing finish (Examples 1 to 3) and control samples without printing finish (Comparative Examples 1 to 3) were prepared. In Table 1, “Ny” represents nylon, “PE” represents polyester, and “Pu” represents polyurethane.

In the test samples with printing finish, the printed layer was formed on the front side of the base fabric. On the front side of the base fabric, a pattern in which a large number of printed portions constituting the printed layer were two-dimensionally and repeatedly arranged was drawn over the entire surface. In the region where the pattern was drawn, the proportion of the area of the printed layer to the total area of the front side of the base fabric was 50%, and the area of each of the figures (the area of each printed portion) was 5 mm². The control samples without printing finish were the same as the test samples in base fabric, but did not have the printed layer. This aspect applies in Test 2 and the subsequent test described later.

Here, by the test method used in this Example, a test sample (Example) and a control sample (Comparative Example) are attached side by side on a sample table inclined at 45°, a heating plate at 90° C. is set in parallel with the sample table and 15 cm in front of the samples, the surface temperatures of both samples are measured with a Thermoview, and a temperature difference is obtained.

TABLE 1

| Base fabric | | Presence or absence of | Example/Comparative |
|---|---|---|---|
| Texture | Fibers used | printing finish | Example |
| Smooth | Ny100% | with printing finish | Example 1 |
| | | without printing finish | Comparative Example 1 |
| Half tricot | PE100% | with printing finish | Example 2 |
| | | without printing finish | Comparative Example 2 |
| 2-way tricot | Ny75%, Pu25% | with printing finish | Example 3 |
| | | without printing finish | Comparative Example 3 |

Table 2 shows the surface temperatures of Examples, the surface temperatures of Comparative Examples, and the temperature differences between them for each elapsed time for each sample. Through this test, it was confirmed that the heat dissipating effect was obtained in a preferred manner by providing the printing finish. Note that the inventors of the present application conducted the comparative test with and without printing finish on a 100% cotton fabric, a blended fabric of Tencel (registered trademark), and a nylon fabric that is cool to the touch, in addition to the base fabrics shown in Table 1, and confirmed that a good heat dissipating effect was obtained from each of these fabrics.

TABLE 2

| | Surface | | | Surface | | | Surface | | |
|---|---|---|---|---|---|---|---|---|---|
| | temperature (° C.) | | Temperature | temperature (° C.) | | Temperature | temperature (° C.) | | Temperature |
| Elapsed | | Comparative | difference | | Comparative | difference | | Comparative | difference |
| time | Example 1 | Example 1 | (° C.) | Example 2 | Example 2 | (° C.) | Example 3 | Example 3 | (° C.) |
| 1 min | 31.9 | 33.0 | ▴ 1.1 | 32.0 | 33.0 | ▴ 1.0 | 30.0 | 31.4 | ▴ 1.4 |
| 2 mins | 32.8 | 34.3 | ▴ 1.5 | 31.9 | 33.6 | ▴ 1.7 | 31.1 | 32.4 | ▴ 1.3 |
| 3 mins | 33.2 | 34.1 | ▴ 0.9 | 32.5 | 33.7 | ▴ 1.2 | 31.5 | 32.3 | ▴ 0.8 |
| 4 mins | 33.5 | 34.3 | ▴ 0.8 | 32.7 | 33.7 | ▴ 1.0 | 31.7 | 32.8 | ▴ 1.1 |
| 5 mins | 33.5 | 34.8 | ▴ 1.3 | 32.0 | 34.0 | ▴ 2.0 | 31.9 | 33.5 | ▴ 1.6 |

| | | | | | | |
|---|---|---|---|---|---|---|
| — | Mean temperature difference | ▴ 1.1 | Mean temperature difference | ▴ 1.4 | Mean temperature difference | ▴ 1.2 |

### [Test 2: Test Related to Heat Retention Rate, Thermal Resistance, and Like]

In a case where the heat dissipating effect of a fabric is high, the heat retention rate is low, and the CLO value (clo) representing the thermal resistance is low. Therefore, to verify the heat dissipating effect of a fabric on which a printed layer was formed using an ink containing only polysilicon blended as the functional material powder having a heat dissipating function, the heat retention rate, the CLO value, and the innate heat transfer rate were measured for each of the test samples with printing finish (Examples 4 and 5) and the control samples without printing finish (Comparative Examples 4 and 5) in accordance with ASTM D 1518-85, using an ASTM heat retention tester. This measurement test was conducted in an environment with an ambient temperature of 20° C. and a relative humidity of 65%. The results of this measurement are shown in Table 3.

In a test sample with printing finish, the printed layer was formed on the front side of the base fabric. Regarding the types of base fabrics, a nylon smooth material was used in Example 4 and Comparative Example 4, and polyester talf was used in Example 5 and Comparative Example 5. On the front side of the base fabric, a pattern in which a large number of printed portions were two-dimensionally and repeatedly arranged was drawn over the entire surface. The same applies in Comparative Example 6 described later. In the region in which the pattern is formed, the proportion of the area of the printed layer with respect to the total area of the front side of the base fabric was 50%, and the area of each of the printed portions was 5 mm². In the print data, in the region in which the pattern is formed, the proportion of the area of the printed layer was 40%, and the area of each of the printed portions 3a was 4 mm².

TABLE 3

| | | Comparative | | Comparative |
|---|---|---|---|---|
| | Example 4 | Example 4 | Example 5 | Example 5 |
| Heat retention rate (%) | 8.0 | 9.7 | 6.4 | 8.7 |
| CLO value (clo) | 0.05 | 0.06 | 0.04 | 0.05 |
| Innate heat transfer rate of only fabric | 132.7 | 105 | 177.7 | 128.3 |
| (W/m² · K) | | | | |

As can be seen from Table 3, the heat retention rate exceeded 8.2% in Comparative Examples 4 and 5, but was 8.2% or lower in Examples 4 and 5. The innate heat transfer rate was lower than 130 W/m²·K in Comparative Examples 4 and 5, but was 130 W/m²·K or higher in Examples 4 and 5.

### [Test 3: Sensory Test]

For each of the fabrics of Examples 4 and 5 and Comparative Examples 4 and 5, a sensory test for examining the degree of heat dissipation felt by the subject was conducted. In the sensory test, a control sample (Comparative Example 6) that was provided with printing finish but had a proportion of the area of the printed layer of 20% was also used as a test object. In Comparative Example 6, the same nylon smooth material as in Example 4 and others was used as the base fabric. The number of test subjects was three. In the sensory test, fabrics of 25 cm square in size (about the size of a handkerchief) were prepared as the respective fabrics of Examples 4 and 5 and Comparative Examples 4 to 6, and were put on both thighs from above. In Comparative Examples 4 to 6, any of the test subjects felt that heat was accumulated in the fabric and warmed the thighs. In Examples 4 and 5, on the other hand, the test subjects did not feel that their thighs were warmed, which confirmed that a high heat dissipating effect was obtained. In Comparative Example 6, the proportion of the area of the printed layer is considerably smaller than that in Example 4 having a heat retention rate of 8%, and therefore, the heat retention rate can be estimated to be higher than 8.2%. By the sensory test, it was successfully confirmed that a fabric having a heat retention rate of 6% or higher and 8.2% or lower has a sufficient heat dissipating effect as a fabric for a garment in which heat hardly accumulates in the fabric while being worn by a person.

Here, to further enhance the heat dissipating effect (to further lower the heat retention rate), it is conceivable to further increase the proportion of the area of the printed layer or to further increase the area of each of the printed portions. In that case, however, there is a possibility that the stretchability (in particular, the stretch-back properties) of the fabric will be degraded. On the other hand, a fabric having a heat retention rate of 6% or higher and 8.2% or lower can be formed with a printed layer having a proportion of the area of 50% (35% or larger and 65% or smaller) and printed portions each having an area of 5 mm² (7 mm² or smaller), and such a fabric excels in stretchability (in particular, stretch-back properties), in addition to the function of dissipating heat from the fabric.

### INDUSTRIAL APPLICABILITY

The present invention is applicable to a fabric or the like that is used for a garment or the like.

### DESCRIPTION OF REFERENCE CHARACTERS

1 Fabric
2 Base fabric
3 Printed layer
3a Printed portion
5 Pattern

What is claimed is:

1. A fabric comprising:
a base fabric; and
a printed layer printed on a front side of the base fabric,
wherein
the printed layer contains functional material powder having a thermal conductivity of 50 W/m·k or higher and a function of dissipating heat from the fabric,
a pattern in which a large number of printed portions constituting the printed layer are two-dimensionally and repeatedly arranged is formed on the front side of the base fabric, each of the large number of printed portions representing one figure,
a proportion of area of the printed layer is 35% or larger and 65% or smaller with respect to a region in which the pattern is formed, and the area of each of the large number of printed portions is 7 mm² or smaller, and
the printed layer contains only polysilicon powder as the functional material powder having the function of dissipating heat from the fabric.

2. The fabric according to claim 1, wherein a fabric portion in the region in which the pattern is formed has a heat retention rate of 6.0% or higher and 8.2% or lower.

3. The fabric according to claim 1, wherein the pattern is formed over an entire surface on the front side of the base fabric.

4. A garment comprising the fabric according to any one of claim 1.

5. A method for manufacturing a fabric, the method comprising a printing step of performing printing on a front side of a base fabric with a printing apparatus using an ink in which at least functional material powder having a thermal conductivity of 50 W/m·k or higher and a function of dissipating heat from the fabric and a binder are blended, and forming a printed layer on the front side of the base fabric,
wherein
the printing step is a step of forming a pattern in which a large number of printed portions constituting the printed layer are two-dimensionally and repeatedly arranged on the front side of the base fabric, each of the large number of printed portions representing one figure,
in print data to be used as input data for the printing apparatus, a proportion of area of the printed layer is 30% or larger and 60% or smaller with respect to a region in which the pattern is formed, and the area of each of the large number of printed portions is 6 mm² or smaller, and
the printed layer contains only polysilicon powder as the functional material powder having the function of dissipating heat from the fabric.

6. A method for manufacturing a fabric, the method comprising a printing step of performing printing on a front side of a base fabric with a printing apparatus using an ink in which at least polysilicon powder as a functional material powder having a thermal conductivity of 50 W/m·k or higher and a function of dissipating heat from the fabric and a binder are blended, and forming a printed layer on the front side of the base fabric,
wherein
the printing step is a step of forming a pattern in which a large number of printed portions constituting the printed layer are two-dimensionally and repeatedly arranged on the front side of the base fabric, each of the large number of printed portions representing one figure,
in print data to be used as input data for the printing apparatus, a proportion of area of the printed layer is 30% or larger and 60% or smaller with respect to a region in which the pattern is formed, and the area of each of the large number of printed portions is 6 mm² or smaller, and
the polysilicon powder accounts for 3% by weight to 5% by weight in the entire materials of the ink.
